(19) United States
(12) Patent Application Publication
(10) Pub. No.: US 2026/0302670 A1
(43) Pub. Date: Oct. 1, 2026

(54) ELECTRICAL CONNECTOR

(71) Applicant: BIZLINK INTERNATIONAL CORP., New Taipei City (TW)

(72) Inventors: Hongping SU, New Taipei City (TW); Haoran ZOU, New Taipei City (TW)

(21) Appl. No.: 19/089,025

(22) Filed: Mar. 25, 2025

(51) Int. Cl. H01R 13/04; H01R 13/506

(52) U.S. Cl. CPC H01R 13/04; H01R 13/506

(57) ABSTRACT

An electrical connector includes an insulation housing and a terminal module. The insulation housing has two vertical sidewalls which define a top opening and a bottom opening, and each vertical sidewall has a hook member at the bottom opening. The terminal module is arranged in the insulation housing and includes two conductive terminal arrays, wherein each conductive terminal array has an inner layer terminal and an outer layer terminal, the hook member engages a depression region of the outer layer terminal to prevent displacement of each conductive terminal array.

### BACKGROUND

### Field of Disclosure

The present disclosure relates to an electrical connector, and more particularly to an electrical connector utilized in a rack-mountable server.

### Description of Related Art

Rack-mounted servers rely on various electrical connectors for power, data, and peripheral connections. However, several issues can arise due to space constraints, accessibility, and mechanical stress.

Rack servers are designed to maximize density, often leaving little room for large or bulky connectors. This can make installation, removal, and cable management challenging. Connectors located near the rear or between closely packed components may be hard to reach, requiring extra effort for maintenance or replacements.

The prior art TW202312586A discloses an electrical connector utilized in a rack-mountable server. The electrical connector is mounted on a bus bar within the server. However, the electrical connector is still found to have a vertical height that causes space constraint and accessibility issues.

### SUMMARY

The present disclosure provides an improved electrical connector to deal with the needs of the prior art problems.

In one or more embodiments, an electrical connector includes an insulation housing and a terminal module. The insulation housing has two vertical sidewalls which define a top opening and a bottom opening, and each vertical sidewall has a hook member at the bottom opening. The terminal module is arranged in the insulation housing and includes two conductive terminal arrays, wherein each conductive terminal array has an inner layer terminal and an outer layer terminal, the hook member engages a depression region of the outer layer terminal to prevent displacement of each conductive terminal array.

In one or more embodiments, an electrical connector includes an insulation housing and a terminal module. The insulation housing has two vertical sidewalls which define a top opening and a bottom opening, and each vertical sidewall has a hook member at the bottom opening, wherein a ratio of a width to a height of the insulation housing ranges from 0.7 to 2.0. The terminal module is disposed in the insulation housing and includes two conductive terminal arrays, wherein the hook member engages a depression region of each conductive terminal array to prevent displacement of each conductive terminal array.

In sum, the electrical connector disclosed herein includes an insulation housing and a terminal module which are specifically designed to have a proper width height ratio in order to minimize the volume of the electrical connector as small as possible.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a perspective view of an electrical connector viewed from an upper side according to some embodiments of the present disclosure;

FIG. 2 illustrates a perspective view of an electrical connector viewed from a lower side according to some embodiments of the present disclosure;

FIG. 3 illustrates a cross sectional view of the electrical connector in FIG. 1 taken along 3-3;

FIG. 4 illustrates a perspective view of an insulation housing of an electrical connector viewed from a lower side according to some embodiments of the present disclosure;

FIG. 5 illustrates a side view of the insulation housing in FIG. 4; and

FIG. 6 illustrates a perspective view of a terminal module of an electrical connector according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

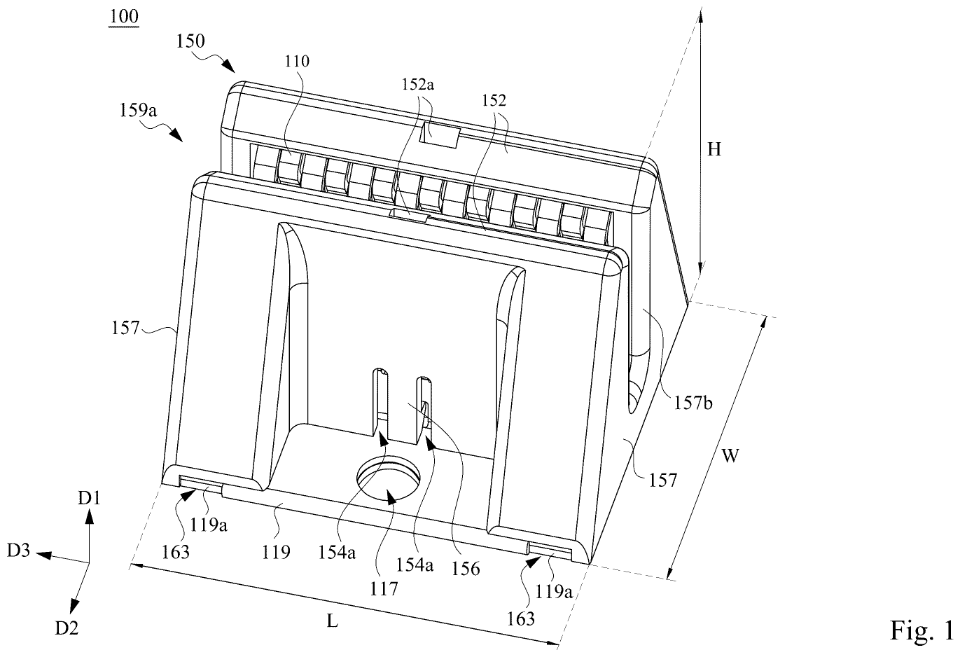

FIGS. 1 to 6 are illustrated in true proportion. To keep the specification concise, the proportions of each component are not listed one by one, but the proportion and position of each component should be regarded as part of the specifications. There are three orientations D1, D2 and D3 illustrated in the drawings to demonstrate the position relationship. The direction D1 is a vertical direction. The direction D2 is a horizontal direction perpendicular to the direction D1. The direction D3 is another horizontal direction perpendicular to the directions D1 and D2.

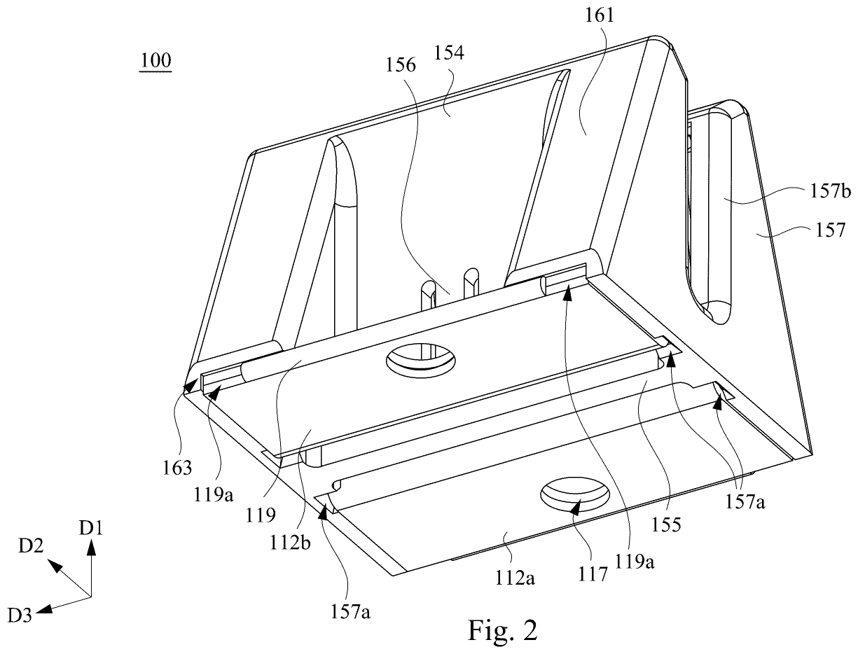

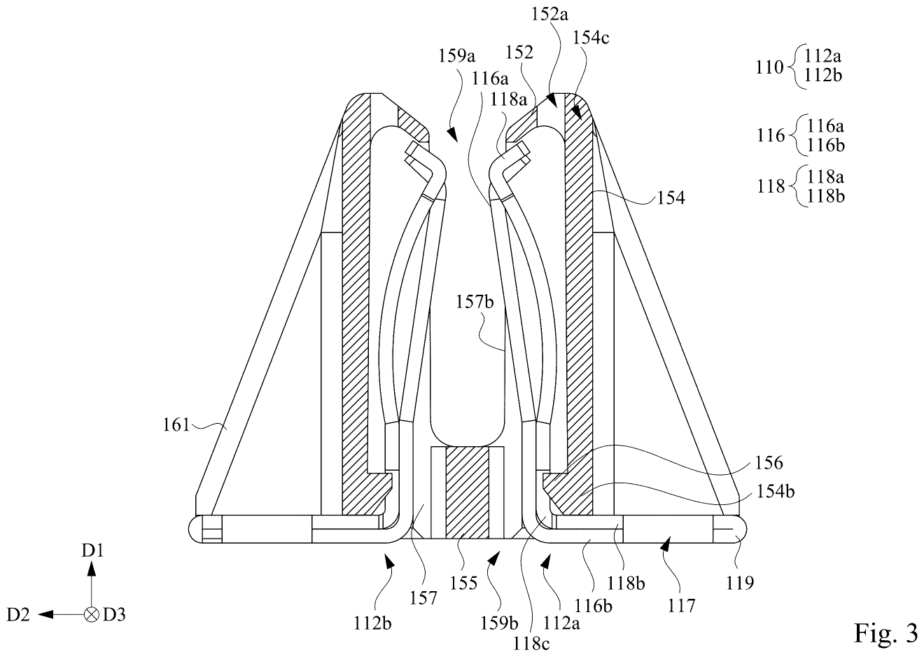

Reference is made to FIGS. 1-3, FIG. 1 illustrates a perspective view of an electrical connector 100 viewed from an upper side, FIG. 2 illustrates a perspective view of the electrical connector 100 viewed from a lower side, and FIG. 3 illustrates a cross sectional view of the electrical connector in FIG. 1 taken along 3-3. The electrical connector 100 is utilized in a rack-mountable server to facilitate power, data, and signal transmission between different components. The electrical connector 100 is composed of an insulation housing 150 and a conductive terminal module 110. The insulation housing 150 is made from various plastic or polymer materials that provide electrical insulation, mechanical strength, heat resistance, and chemical durability. The conductive terminal module 110 is typically made from metal alloys that offer high conductivity, corrosion resistance, and durability.

In some embodiments of the present disclosure, the insulation housing 150 has two vertical sidewalls 154 which define a top opening 159a and a bottom opening 159b. The two vertical sidewalls 154 generally extend along the directions D1 and D3. Two roofs 152 extend slightly downwards from a top edge 154c of the two vertical sidewalls 154 respectively. Each roof 152 is connected to the top edge 154c of the vertical sidewall 154 at a tilt, and the top opening 159a is defined between the two roofs 152, thereby allowing a male electrical connector to plug in. Each roof 152 has a top vertical passage 152a, i.e., a vertical through hole passage. Each vertical sidewall 154 further has a hook member 156 at its bottom edge 154b, e.g., at the bottom opening 159b. The hook member 156 protrudes from the bottom edge 154b of the vertical sidewall 154 towards the conductive terminal module 110.

Referring to FIG. 1, the top vertical passage 152a is aligned with the hook member 156 in a vertical direction, i.e., direction D1. The hook member 156 is formed between two cutouts 154a of each vertical sidewall 154, and the two cutouts 154a are in substantially parallel with each other in a vertical direction. In some embodiments of the present disclosure, the hook member 156 is located at a middle position of each vertical sidewall 154 along a horizontal direction, i.e., direction D3.

The insulation housing 150 further includes two support vertical walls 157 which generally extend along the directions D1 and D2. In some embodiments of the present disclosure, the insulation housing has a height H ranging from 16 mm to 26 mm along the direction D1, and the insulation housing 150 has a width W ranging from 20 mm to 31 mm along the direction D2. The insulation housing 150 may have a length L ranging from 23 mm to 36 mm along the direction D3. In some embodiments of the present disclosure, the ratio of the width W to the height H of the insulation housing 150 ranges from 0.7 to 2.0 in order to minimize the volume of the electrical connector 100 as small as possible. Preferably, the ratio of the width W to the height H of the insulation housing 150 ranges from 1.0 to 1.4.

The two vertical sidewalls 154 and two roofs 152 are connected between the two support vertical walls 157 which are in parallel with each other. Each support vertical wall 157 is perpendicularly connected to the two vertical sidewalls 154. U shaped openings 157b are also formed on the two vertical sidewalls 154 to correlate with the top opening 159a.

The conductive terminal module 110 is installed within the insulation housing 150. The conductive terminal module 110 includes two conductive terminal arrays 112a and 112b which are mirror images of each other. Each conductive terminal array (112a or 112b) has an inner layer terminal 116 and an outer layer terminal 118 which has a vertical portion and a horizontal portion. In particular, the inner layer terminal 116 has a vertical portion 116a along the direction D1 and a horizontal portion 116b along the direction D2 that is a continuous layer, and the outer layer terminal 118 has a vertical portion 118a along the direction D1 and a horizontal portion 118b along the direction D2 that is another continuous layer stacked over the inner layer terminal 116. The inner layer terminal 116 and the outer layer terminal 118 are also a continuous layer and have a common fold edge 119, namely, the inner layer terminal 116 and the outer layer terminal 118 designed to be a fold-stacked structure to minimize its volume. In some embodiments of the present disclosure, the common fold edge 119 may have two opposite end sections 119a being removed as cutouts for easily folding along the common fold edge 119.

Referring to FIG. 3, a bottom edge 154b of each vertical sidewall 154 abuts against a horizontal portion 118b of the outer layer terminal 118. The hook member 156 protrudes from the bottom edge 154b of each vertical sidewall 154 to engage a depression region 118c of each conductive terminal array (112a or 112b).

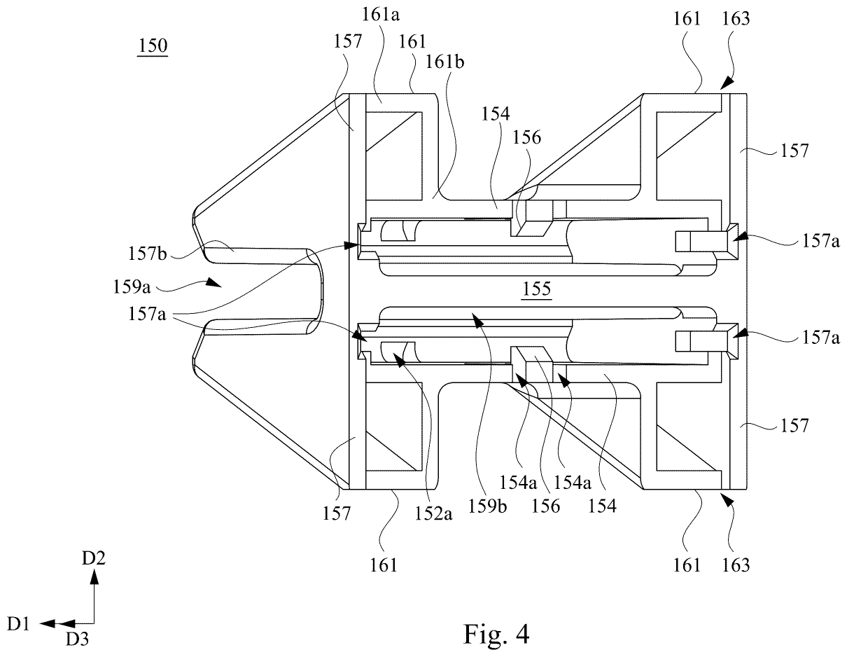

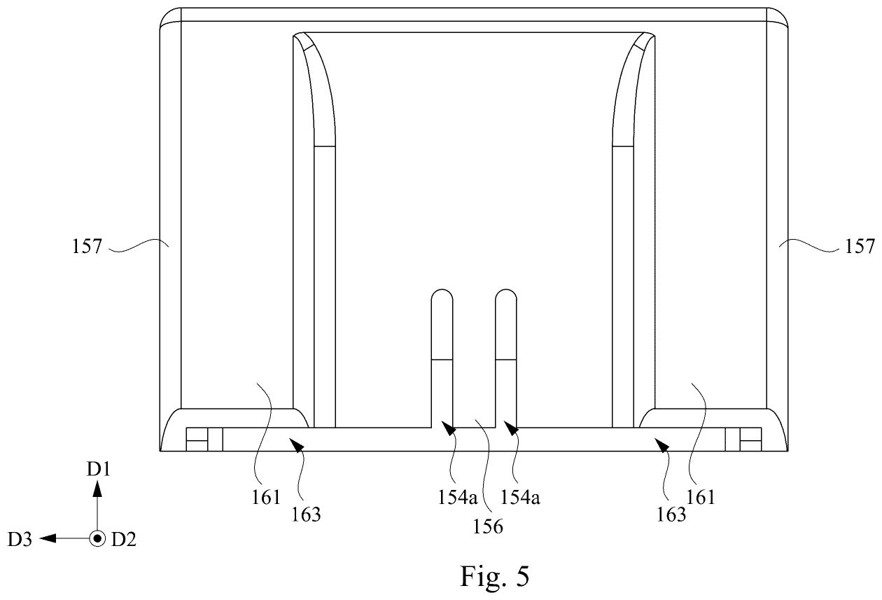

Reference is made to FIGS. 4 and 5, FIG. 4 illustrates a perspective view of the insulation housing 150 from a lower side, and FIG. 5 illustrates a side view of the insulation housing in FIG. 4. The insulation housing 150 further has two support structures 161 connected to each vertical sidewall 154 and each support vertical wall 157. In particular, each support structure 161 has an end 161a connected to the support vertical wall 157 and another end 161b connected to the vertical sidewall 154 in order to insure a strength of the support vertical wall 157 and vertical sidewall 154. An inner side of each support vertical wall 157 has vertical slots 157a to accommodate at least a portion of the vertical portion of the two conductive terminal arrays 112a and 112b. Two support vertical walls 157 and two support structures 161 collectively define an accommodation space and a side passage 163 for the horizontal portions of the two conductive terminal arrays 112a and 112b. Each side passage 163 exposes the corresponding common fold edge 119 and its end section 119a. In some embodiments of the present disclosure, the two cutouts 154a of each vertical sidewall 154 are exposed between the two support structures 161.

Referring FIGS. 2 and 4, the insulation housing 150 further has a central beam 155 connected between the two support vertical walls 157. Two ends of the central beam 155 are perpendicularly connected to the two support vertical walls 157 respectively. The central beam 155 is at the bottom opening 159b between the two vertical sidewalls 154. The hook member 156 is located at a middle position of each vertical sidewall 154. The two conductive terminal arrays 112a and 112b can be installed and pushed from the bottom of the insulation housing 150 until the two hook member 156 engage and hold the two conductive terminal arrays 112a and 112b respectively.

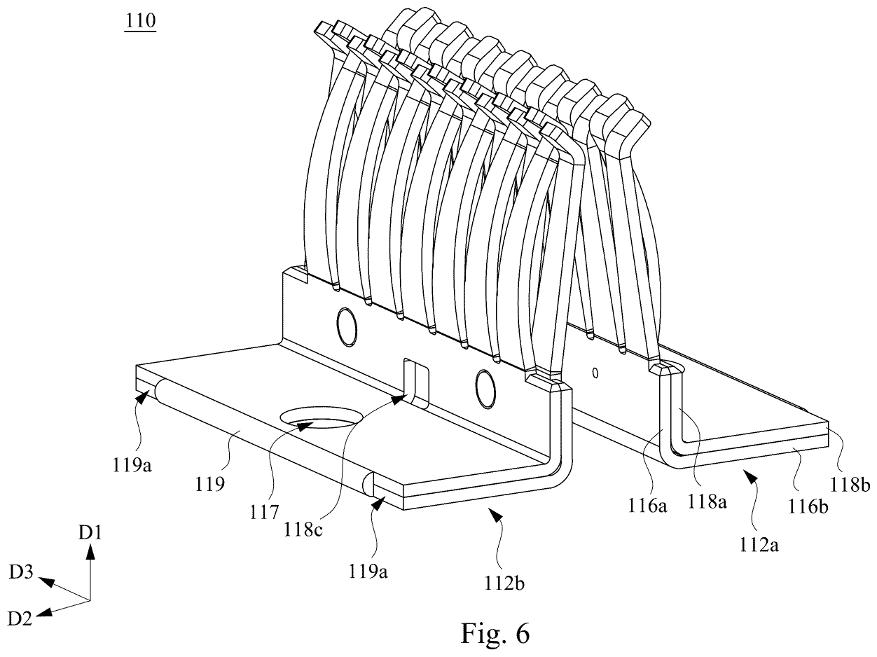

Reference is made to FIG. 6 which illustrates a perspective view of a conductive terminal module 110 of an electrical connector. Each conductive terminal array (112a or 112b) of the conductive terminal module 110 includes a vertical portion (116a, 118a) and a horizontal portion (116b, 118b). The vertical portion (116a, 118a) of each conductive terminal array (112a or 112b) has a depression region 118c at a middle position along the direction D3. The depression region 118c may be a through hole on the outer layer terminal 118. The horizontal portion (116b, 118b) of each conductive terminal array (112a or 112b) also has a securing hole 117 through which a fastener may be used to fix the electrical connector on a circuit board. In some embodiments of the present disclosure, the securing hole 117 is aligned with the depression region 118c along the direction D3.

Referring to FIGS. 3 and 6, the hook member 156 of each vertical sidewall 154 engages the depression region 118c of each conductive terminal array (112a or 112b) to prevent displacement of each conductive terminal array, e.g., prevent each conductive terminal array (112a or 112b) from slipping out of the bottom opening 159b. Each roof 152, which extends from a top edge 154c of the vertical sidewall 154, is configured to restrict a top end of the vertical portion (116a, 118a) of each conductive terminal array (112a or 112b). Therefore, the two conductive terminal arrays 112a and 112b can be secured firmly within the insulation housing 150 to obtain a compact volume.

In sum, the electrical connector disclosed herein includes an insulation housing and a terminal module which are specifically designed to have a proper width/height ratio in order to minimize the volume of the electrical connector as small as possible.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electrical connector comprising:
an insulation housing having two vertical sidewalls which define a top opening and a bottom opening, each vertical sidewall has a hook member at the bottom opening; and
a terminal module disposed in the insulation housing and comprising two conductive terminal arrays, wherein each conductive terminal array has an inner layer terminal and an outer layer terminal, the hook member engages a depression region of the outer layer terminal to prevent displacement of each conductive terminal array.

2. The electrical connector of claim 1, wherein the hook member is defined between two cutouts of each vertical sidewall.

3. The electrical connector of claim 2, wherein each conductive terminal array has a vertical portion in a first direction and a horizontal portion in a second direction perpendicular to the first direction, the insulation housing further has two support vertical walls and two support structures which define an accommodation space and a side passage for the horizontal portion, the vertical portion is disposed between the two vertical sidewalls and between the top opening and the bottom opening.

4. The electrical connector of claim 3, wherein the two cutouts of each vertical sidewall are exposed between the two support structures.

5. The electrical connector of claim 1, wherein a bottom edge of each vertical sidewall abuts against a horizontal portion of the outer layer terminal.

6. The electrical connector of claim 3, wherein the inner layer terminal and the outer layer terminal are continuous layer and have a common fold edge exposed by the side passage.

7. The electrical connector of claim 3, wherein each support vertical wall is perpendicularly connected to the two vertical sidewalls and has vertical slots to accommodate at least a portion of the vertical portion.

8. The electrical connector of claim 1, further comprising two roofs extending from a top edge of the two vertical sidewalls respectively, each roof has a top vertical passage that is aligned with the hook member in a vertical direction.

9. The electrical connector of claim 8, wherein the top opening is defined between the two roofs.

10. The electrical connector of claim 1, wherein the insulation housing has a height ranging from 16 mm to 26 mm, a width ranging from 20 mm to 31 mm, and a length ranging from 23 mm to 36 mm.

11. An electrical connector comprising:
an insulation housing having two vertical sidewalls which define a top opening and a bottom opening, each vertical sidewall has a hook member at the bottom opening, wherein a ratio of a width to a height of the insulation housing ranges from 0.7 to 2.0; and
a terminal module disposed in the insulation housing and comprising two conductive terminal arrays, wherein the hook member engages a depression region of each conductive terminal array to prevent displacement of each conductive terminal array.

12. The electrical connector of claim 11, wherein the hook member is located at a middle position of each vertical sidewall along a horizontal direction.

13. The electrical connector of claim 11, wherein the hook member is defined between two cutouts of each vertical sidewall, and the two cutouts are in parallel with each other in a vertical direction.

14. The electrical connector of claim 11, further comprising two roofs extending from a top edge of the two vertical sidewalls respectively, and the top opening is defined between the two roofs.

15. The electrical connector of claim 14, wherein each roof has a top vertical passage that is aligned with the hook member in a vertical direction.

16. The electrical connector of claim 11, further comprising two support vertical walls, wherein the two vertical sidewalls are connected between the two support vertical walls, and each support vertical wall has a vertical slot to accommodate at least a vertical portion of each conductive terminal array.

17. The electrical connector of claim 11, wherein each conductive terminal array has an inner layer terminal and an outer layer terminal, the depression region is a through hole on the outer layer terminal.
